(19) United States
(12) Patent Application Publication
(10) Pub. No.: US 2017/0112097 A1
(43) Pub. Date: Apr. 27, 2017

(54) Equine Barrier Training and Desensitizing Device

(71) Applicant: Jeffrey S. Jasper, Sturgis, SD (US)

(72) Inventor: Jeffrey S. Jasper, Sturgis, SD (US)

(21) Appl. No.: 14/920,702

(22) Filed: Oct. 22, 2015

(51) Int. Cl. A01K 15/02

(52) U.S. Cl. CPC A01K 15/02

(57) ABSTRACT

An automatically resetting rodeo barrier training and desensitizing device. This device is constructed to train horses to properly act with respect to rodeo barriers in performance of certain rodeo contests, such as, by way of example, steer roping and calf roping. The device further trains horses to be accustomed to stimulation to their legs and bodies so that the horse will not succumb to panic or a flight reaction. A barrier arm makes a makeshift rodeo barrier, which rotates about the support member allowing the animal to pass through. After the animal has moved through, the barrier arm is returned automatically to resting position.

### BACKGROUND OF THE INVENTION

The rodeo is a popular form of western competition and entertainment. Traditionally, a rodeo includes various events involving bovine or equine animals, and a human contestant. Generally, the human contestant tests his abilities against the speed, strength and agility of the animal.

In timed rodeo events, such as calf roping or steer roping, a barrier is employed. A barrier is a line at the front of the contestant's starting box which the contestant and his horse cannot cross until the steer or calf has a head start. The barrier is typically a breakaway rope that is pulled across the exit of the starting box. Breaking the barrier (breaking the rope or leaving too early) results in a penalty added to the overall time of the competitor.

In rodeo events, especially among highly competitive professional riders, the timing of events for judging is exceedingly critical. An event can be won or lost by a mere fraction of a second. Because the success of a Rodeo competitor can depend upon milliseconds, preparation and training of the horse is vital. Without proper training with respect to barriers, a horse may likely attempt to leap over the rope barrier rather than running through it. Additionally, an untrained or improperly trained horse may hesitate or be reluctant to pass through the barrier. If the horse either attempts to jump the barrier or hesitates, it will undoubtedly result in a poor run and may result in penalties or disqualification of the participant.

Currently known methods of teaching rodeo horses to pass through, rather than over, a rodeo barrier typically involve setting a rope or barrier between two vertical posts. Once the rope or barrier is set, the trainer will either guide the horse to walk into the rope or barrier either by riding the horse or while walking by guiding the horse by its reins. Once the horse walks into and against the rope or barrier, it will detach, allowing the horse to pass between the posts. Alternatively, a second individual may hold a rope or barrier across the gap between two posts. In this instance, once the horse walks into the rope or barrier, the person holding it will drop one end, allowing the horse to pass between the posts.

The methods and devices that exist in the prior art are disadvantageous primarily because they are not automatically resetting. The rope or barrier will need to be reset after each pass by the horse. This will necessarily require the rider to dismount the horse in order to reset the rope. This causes undue delay, expenditure of energy, and frustration for both the rider and the horse. Under the alternative method detailed above, a second individual is required to train the horse. The present invention provides training for horses that is significantly safer than the prior art in that no human needs to stand or be positioned next to the horse. This significantly reduces the risk of a human being bumped, kicked, hit, run over, or similarly injured.

It would be highly advantageous, therefore, to provide a means for training a rodeo horse to pass through a rodeo barrier which remedies the deficiencies in the prior art. Accordingly, it is a principal object of the present invention to provide improved training apparatus for use in training rodeo horses. More specifically, the present invention is a durable and automatically resetting barrier training device. Through use of the present invention, a single individual may train his horse to properly approach and pass through a barrier without the need to dismount or reset the barrier in any fashion.

Because the present invention is automatically resetting, each pass through the barrier will require less time than under the prior art. Thereby, the horse may receive more meaningful training within the same time frame as compared to under the prior art.

The present invention possesses an additional advantage over the prior art in that it will also serve to desensitize a horse to stimulus to its legs and body. Horses need to be trained to become accustomed to the stimulus of objects coming into contact with their leg, such as twigs and bushes. If the horse is not so trained, they may become easily spooked and succumb to its flight instinct upon stimulus to their legs or body. As a result, the rider may be thrown from his saddle or the horse may ignore commands from the rider and flee. This may easily result in injury to the rider or to the horse. Thus, proper training of a trail horse is specifically desired so as to reduce the risk of injury and discomfort for both the rider and the horse.

The present invention will serve to train horses by introducing the horse to stimulation similar to that expected on a trail and other locations where a horse may be ridden. Each time the horse passes through the barrier created by the present invention, the Barrier Arm or an extension thereof will graze the side and leg of the horse. Through repeated use of the present invention, the horse will become accustomed to stimulation to its legs and thereby will be significantly less likely to become spooked or flee while riding a trail. The prior art is disadvantageous as those methods and devices do not provide any stimulation to the sides or legs of the horses as the barrier is disengaged or dropped as the horse passes through the barrier.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a front view of the present invention.

FIG. 2 is a side view of the present invention with the Spring(s) 116 removed.

FIG. 3 is a front view of the present invention focused upon the connection between the Support Member 110 and Barrier Arm 112 with the Spring(s) 116 and Annular Spring Attachment(s) 118 removed and with the Barrier Arm 112 rotated ninety degrees about the central axis.

### REFERENCE NUMERALS

Support Member 110
Barrier Arm 112
Fin 114
Spring 116
Annular Spring Attachment 118

### DETAILED DESCRIPTION OF INVENTION

The present invention comprises a rigid, vertical Support Member 110, a Barrier Arm 112, and a means for returning the Barrier Arm 112 to resting position after it rotates about the central axis of the Support Member 110.

The Barrier Arm 112 is affixed to the superior terminus of the Support Member 110. The Barrier Arm 112 extends outwardly approximately perpendicular from the Support Member 110. The Barrier Arm 112 is supported on the Support Member 110 and is rotatable relative to that Support Member 110 about that central axis. When torque is applied to the Barrier Arm 112 the Barrier Arm 112 will rotate about the central axis. Rotation of the Barrier Arm 112 facilitates opening and closing of the barrier.

The Barrier Arm 112 hangs off the Support Member 110 in a manner such that the Barrier Arm 112 creates a force acting to tip the Support Member 110 to one side. For this reason, the Support Member 110 is reinforced in some manner to prevent tipping.

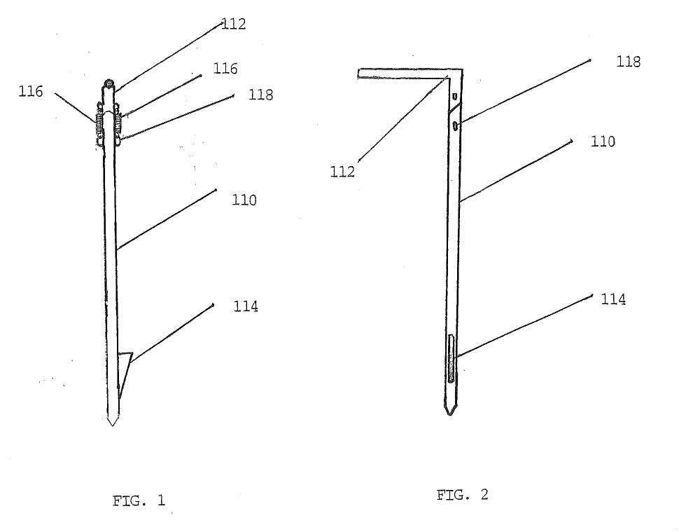

Now referring to FIG. 1 and FIG. 2, those figures show one particular embodiment of the present invention. In this embodiment of the present invention, the Support Member 110 is a narrow, tubular structure. The Barrier Arm 112 is an L-shaped arm, whereby the horizontal portion creates a barrier for a horse to pass through and the vertical portion is adapted to connect to the superior end of the Support Member 110. The Barrier Arm 112, once the present invention is anchored, will be elevated to a height corresponding with the chest or upper forearm of a horse. The Barrier Arm 112 will thus be elevated approximately thirty-six inches above the ground.

In this embodiment, the inferior end of the Barrier Arm 112 is narrowed and prolate in form. This prolate end is sheathed by the superior end of the Support Member 110, which itself is bored to accommodate the prolate inferior end of Barrier Arm 112. This sheathed prolate end of the Barrier Arm 112 supports the Barrier Arm 112 and further provides a pivot point for the Barrier Arm 112 to rotate about the central axis. The inferior terminus of the Support Member 110 is pointed so as to reduce the resistance experienced if the device is driven into the ground or soil.

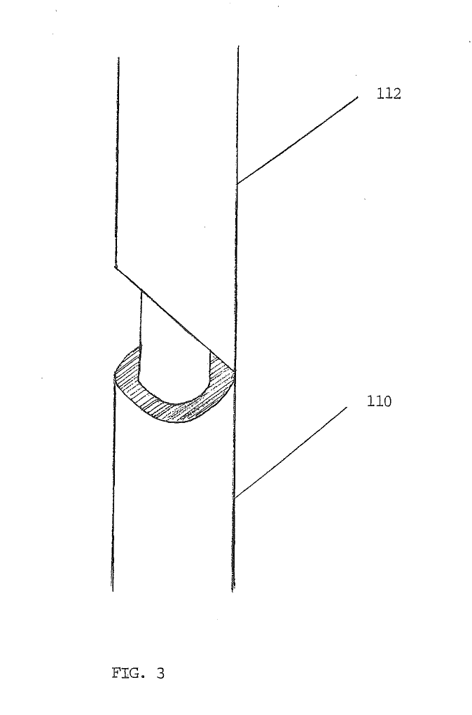

In this particular embodiment, the means for returning the Barrier Arm 112 to resting position comprises two Springs 116, one sinister and one dexter as well as the mitered connection between the Support Member 110 and Barrier Arm 112, as shown in FIG. 3.

With regard to the mitered connection between the Support Member 110 and Barrier Arm 112, as shown in FIG. 3, the superior end of Support Member 110 and the portion of the Barrier Arm 112 that is supported on the superior end of Support member 110 are each mitered at corresponding angles and sized to mate as shown in FIG. 3. When the Barrier Arm 112 is at its resting position, the mitered portions of the Barrier Arm 112 and Support Member 110 create a flush connection. When in resting position, no portion of the prolate inferior end of the Barrier Arm 112 is visible. When torque is applied to the Barrier Arm 112, the Barrier Arm 112 is elevated relative to the Support Member 110 owing to the mitered connection between the Barrier Arm 112 and Support Member 110. The connection is adapted to return the Barrier Arm 112 to its lowermost position owing to the weight of the Barrier Arm 112 and consequently permit the return of the Barrier Arm 112 to its lower-most resting position.

Two Annular Spring Attachments 118, one sinister and one dexter, are affixed to the Support Member 110 radially near the superior end of the Support Member 110. Two additional Annular Spring Attachments 118 are affixed to the Barrier Arm 112 radially near the inferior end of the Barrier Arm 112, one sinister and one dexter. A Spring 116 is affixed to the Annular Spring Attachments 118 whereby one Spring 116 is connected at one end to the sinister Annular Spring Attachment 118 that is affixed to the Support Member 110 and at the other end to the sinister Annular Spring Attachment 118 that is affixed to the Barrier Arm 112. Another Spring 116 is affixed in the same manner to the Annular Spring Attachments 118 that are affixed to the Dexter sides of the Barrier Arm 112 and Support Member 110.

The weight of the Barrier Arm 112 and the downward force provided by sinister and dexter Springs 116 will cause the Barrier Arm 112 to rotate about the central axis and return the Barrier Arm 112 to resting position.

This embodiment of the invention also comprises a triangular Fin 114 affixed upon its longitudinal axis radially to the Support Member 110 as depicted in FIG. 1. The Fin 114 provides a means for person to drive the inferior portion of Support Member 110 into ground using downward force provided by a hammer or other driving tool. The Fin 114 is affixed in such a manner so that the narrow pointed end of the Fin 114 is inferior, as shown in FIG. 1. This orientation of the Fin 114 reduces the resistance the device experiences as it is driven into the soil or ground and thereby decreasing the energy or force necessary to do drive the device into the soil or ground.

The Fin 114 further serves to anchor the invention into the ground. When torque is applied to the Barrier Arm 112, a portion of the tortuous force may be transferred to the Support Member 112. The Fin 114, when embedded in the ground or soil provides sufficient resistance that the Support Member 110 will not rotate about its central axis, thus maintaining a consistent orientation of the present invention.

In this embodiment, the Barrier Arm 112 is shortened and a sheath is bore out at the distal end to accommodate insertion of a further member to elongate the barrier. This elongation member, or barrier extension, will be rigid or semi rigid and in practice, this will likely be a flag. Other embodiments of this invention possess a much longer Barrier Arm 112 which will serve as the entire barrier for the horse to pass through. By utilizing the attachment to the Barrier Arm 112 of a flag or other semi rigid member extension, the length of the barrier is easily adaptable and will reduce risk of injury to the horse as the flag or member extension may bend when the animal applies force to the barrier.

This embodiment of the invention can be used individually, where the distal end of the Barrier Arm 112 or barrier extension, as specified above, is adjacent to a further vertical structure, post or wall, which can then provide the outer wall of the barrier for the animal to pass through. Most commonly however, this invention will be utilized in pairs where each device will be anchored and positioned so that the distal ends of the Barrier Arm 112 of each, or any extension affixed thereto, will meet at a central point to create a barrier or gate for the animal to pass through.

The embodiment using a pair of the present invention will reduce risk of the animal or rider being harmed by the Barrier Arm 112 by virtue of the counter-rotational torque applied to the Barrier Arm 112 by virtue of the Springs 116. If the counter-rotational torque is too great, the horse could be scratched or injured as a result of the Barrier Arm 112 scraping or hitting against the skin of the horse. By using a pair of the present invention, the counter-rotational torque of two Barrier Arms 112 will be less than that exerted by one Barrier Arm 112 as the distance each Barrier Arm 112 must rotate about the central axis for the horse to pass through the barrier is reduced.

Thus, at least one embodiment of this present invention provides a more efficient device that will increase the amount of training an individual can provide to a rodeo horse.

While the above description contains many specificities, these should not be construed as limitations on the scope, but rather as an exemplification of one embodiment thereof. Many other variations are possible. Further modification and adaptation to these embodiments will be apparent to those skilled in the art and may be implemented without departing from the scope or spirit of the invention. Accordingly, the scope should be determined not by the embodiment illustrated, but by the appended claims and their legal equivalents.

I claim:

1. An equine barrier training and desensitizing device comprising:
A substantially vertical support member;
A barrier arm rotatable about the support member; and
A means for returning said barrier arm to its resting position after rotating about said support member.

2. The device described in claim 1 wherein said means for returning said barrier arm to its resting position is one or more springs.

3. The device described in claim 2 wherein said springs are attached on one end to said support member and on the other end to said barrier arm.

4. The device described in claim 3 wherein said springs are attached to annular spring attachments affixed to the support member and barrier arm.

5. The device described in claim 1 wherein said means for returning the barrier arm to its resting position is that the superior terminus of said support member and the portion of said barrier arm connecting to said support member are mitered at corresponding angles, as described, so that said barrier arm and support member are flush while the barrier arm is at resting position but said barrier arm will elevate relative to said support member when said barrier arm rotates about said support member.

6. The device described in claim 1 which further comprises a means for attachment to the distal end of said barrier arm of a barrier extension or flag.

7. The device described in claim 6 wherein said means for attachment is a sheath bore into the distal end of said barrier arm whereby a flag or barrier extension may be insertably attached.

8. The device described in claim 1 wherein the inferior terminus of said support member is pointed.

9. The device described in claim 8 which further comprises a means for driving the inferior portion of said support member into the ground.

10. The device described in claim 9 wherein said means for driving the inferior portion of said support member into the ground comprises a triangular fin affixed radially to said support member.

11. The device described in claim 8 which further comprises a means for anchoring the device in the ground and preventing rotation of said support member.

12. The device described in claim 11 wherein said means for anchoring the device in the ground comprises a triangular fin affixed radially to said support member.
